(19) United States
(12) Patent Application Publication
(10) Pub. No.: US 2012/0117870 A1
(43) Pub. Date: May 17, 2012

(54) DRY-CAST CONCRETE PLANTER BOX

(75) Inventors: John T. Ness, Stillwater, MN (US); Jeffrey A. Ness, Oak Park Heights, MN (US)

(73) Assignee: NESS INVENTIONS, INC, St. Paul, MN (US)

(21) Appl. No.: 13/045,359

(22) Filed: Mar. 10, 2011

Related U.S. Application Data
(60) Provisional application No. 61/312,502, filed on Mar. 10, 2010.

(51) Int. Cl. A01G 9/02

(52) U.S. Cl. 47/65.7

(57) ABSTRACT

A dry-cast concrete planter box including opposed front and rear walls, opposed side walls extending between the front and rear walls, a bottom side extending between the front, rear, and side walls, a top side including a rim extending around a perimeter of the top side along an upper edge of the front, rear, and side walls, and at least one interior compartment extending from the top side partially through the planter box toward the bottom side which is configured to hold soil or other planting material.

### CROSS-REFERENCE TO RELATED APPLICATION

The subject matter of this application is related to the subject matter of U.S. Provisional Patent Application No. 61/312,502, filed Mar. 10, 2010, priority to which is claimed under 35 U.S.C. §119(e) and which is incorporated herein by reference.

### BACKGROUND OF THE INVENTION

Decorative precast concrete items, such as bird baths and benches and any number or ornamental items, for example, are typically formed using a wet-casting method wherein wet cast concrete, which is typically defined as having a water-cement ratio of about 0.4 or higher, is poured into a mold or set of forms comprising a negative of the desired item. After the wet-cast concrete has adequately set or cured, the forms are stripped and the concrete item is allowed to finally cure. The forms are then reassembled and the process repeated to produce additional items. Such a process is time consuming and requires multiple and expensive forms if it is desired to simultaneously cast more than one item.

### SUMMARY OF THE INVENTION

In one embodiment, the present invention provides a dry-cast concrete planter box including opposed front and rear walls, opposed side walls extending between the front and rear walls, a bottom side extending between the front, rear, and side walls, a top side including a rim extending around a perimeter of the top side along an upper edge of the front, rear, and side walls, and at least one interior compartment extending from the top side partially through the planter box toward the bottom side which is configured to hold soil or other planting material.

### BRIEF DESCRIPTION OF THE DRAWINGS

FIG. 1 is a perspective view of a dry-cast concrete planter box, according to one embodiment.

FIG. 2A is a front view of the dry-cast concrete planter box of FIG. 1, according to one embodiment.

FIG. 2B is a side view of the dry-cast concrete planter box of FIG. 2, according to one embodiment.

FIG. 3 is a front view of the dry-cast concrete planter box of FIG. 1, according to one embodiment.

FIG. 4 is a front view of the dry-cast concrete planter box of FIG. 1, according to one embodiment.

FIG. 5 is a perspective view illustrating a mold assembly for use in an automated dry-cast concrete block machine and for molding a dry-cast concrete planter box, according to one embodiment.

FIG. 6 is a longitudinal cross-sectional view generally illustrating portions of the mold assembly of FIG. 5, according to one embodiment.

FIG. 7 is a perspective view illustrating portions of the mold assembly of FIG. 5, according to one embodiment.

FIG. 8 is a perspective view illustrating portions of the mold assembly of FIG. 5, according to one embodiment.

FIG. 9 is a longitudinal cross-section of the dry-cast concrete planter box of FIG. 1, according to one embodiment.

FIG. 10 is a longitudinal cross-section of the dry-cast concrete planter box of FIG. 1, according to one embodiment.

### DESCRIPTION OF THE PREFERRED EMBODIMENTS

In the following Detailed Description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

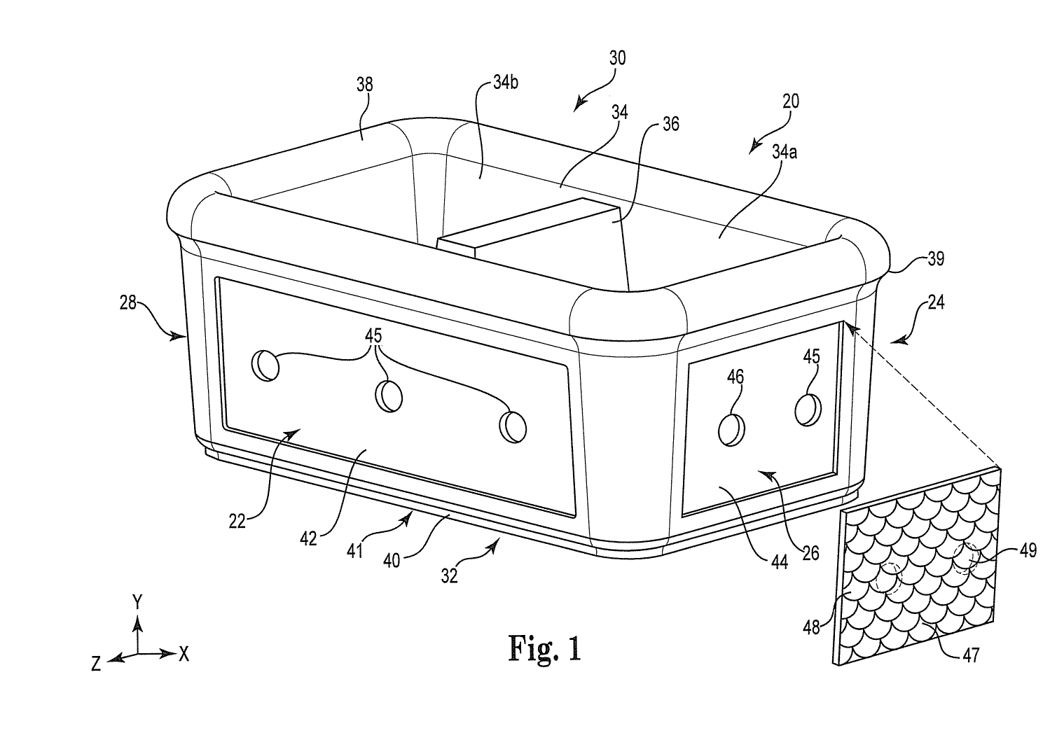

As described herein and illustrated by FIGS. 1-10, dry-cast concrete planter boxes and methods of making dry-cast concrete planter boxes including, among other things, angled front, rear, and side walls, radiused internal and external corners, and a top rim having an overhang, are provided. According to one embodiment, the dry-cast concrete planter boxes include removable and interchangeable decorative panels which are securable to the front, rear, and side walls. According to one embodiment, the dry-cast concrete planter boxes are formed using lightweight concrete.

FIG. 1 is a perspective view of an example of a dry-cast concrete planter box 20 according to one embodiment of the present disclosure. Planter box 20 includes side walls 22, 24, end walls 26, 28, a top side 30, and a bottom side 32, each of which include interior and exterior surfaces. Planter box 20 includes at least one interior compartment 34 for holding soil or other planting material. According to one embodiment, planter box 20 includes a removable partition 36 which subdivides interior compartment 34 into sub-compartments 34a, 34b, not necessarily of equal size.

According to one embodiment, the upper edges of side and end walls 22, 24, 26, 28 are formed or molded so as to form a rim 38 about the perimeter of open top 30. Although illustrated in FIG. 1 having a rounded or bull-nose type shape or appearance, rim 38 may have any number of shapes or configurations, and may be generally rectangular in shape, for example. According to one embodiment, rim 38 may even be separately formed so as to be removable or replaceable. According to one embodiment, as described in greater detail below, rim 38 overhangs the exterior surfaces of side and end walls 22, 24, 26, 28, as indicated at 39, which, in addition to providing a decorative appearance, functions as a grip to enable planter box 20 to be easily lifted and handled.

According to one embodiment, the corners of planter box 20, where side walls 22, 24 merge with end walls 26, 28, such as illustrated by corner 29, are curved or radiused. According to one embodiment, both the external and internal surfaces at such corners are radiused. According to one embodiment, the external and internal surfaces of side and end walls 22, 24, 26, and 28 have a radius of up to 3 inches. It is noted that the radius of the internal and external surfaces at such corners are not required to be the same. In addition to providing a more pleasing appearance, providing corners which are curved or radiused in such a fashion improves the strength and durability of planter box 20, as such curvature tends to decrease the occurrence of chipping both during and after fabrication. According to other embodiments, such corners are not radiused, but simply merge to form a “square” or rectangular corner or other desired shape.

In one embodiment, an upper edge of partition 36 is disposed below an upper surface of rim 38 so that compartments 34a, 34b can be overfilled with soil and cover partition 36 to give the appearance of planter box 20 having a single large compartment 34. In one embodiment, partition 36 is molded such that it can be readily broken or knocked out so as to provide planter box 20 with a single compartment 34 in lieu of sub-compartments 34a, 34b. Although illustrated as having only a single partition 36, planter box 20 may, in other embodiments, include more than one partition 36 so as to subdivide compartment 34 into more than two sub-compartments.

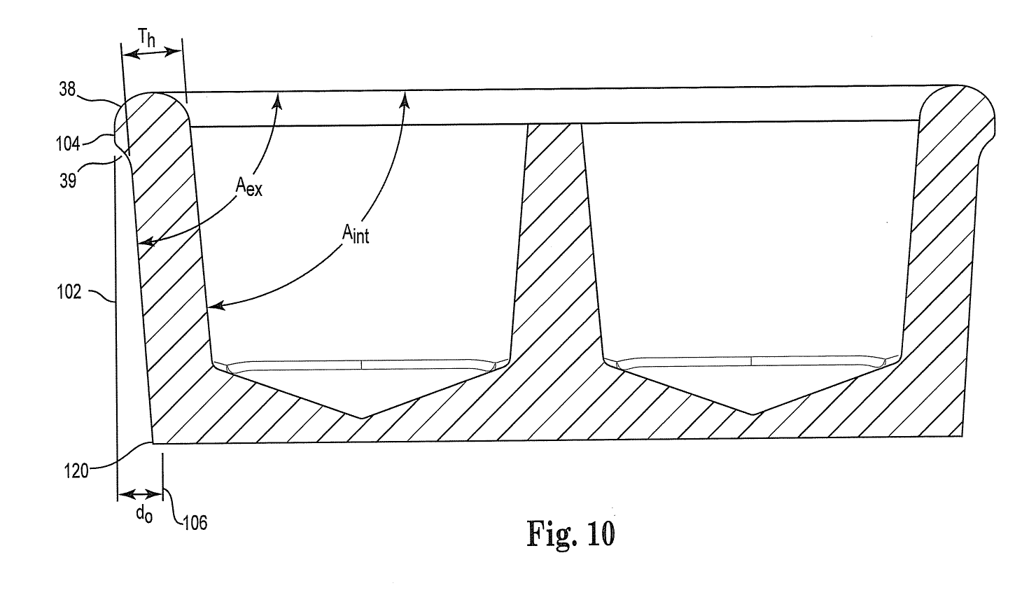

According to one embodiment, as illustrated by FIG. 1, lower edges of the external surfaces of side and end walls 22, 24, 26, 28 are formed or molded so as transition in to recess 40 along an edge shared with bottom side 32 to provide the appearance of a base 41 for planter box 20. It is noted that base 41 may be formed so as to have any number or shapes or configurations, such as to give the appearance of having legs at each of the corners of base 41, for example. In other embodiments, the lower edges of side and end walls 22, 24, 26, and 28 may simply be formed without a transition or recess 40 so as to merge directly with bottom side 32 so that planter box 20 does not have the appearance of a base 41 (see FIG. 10 below, for example).

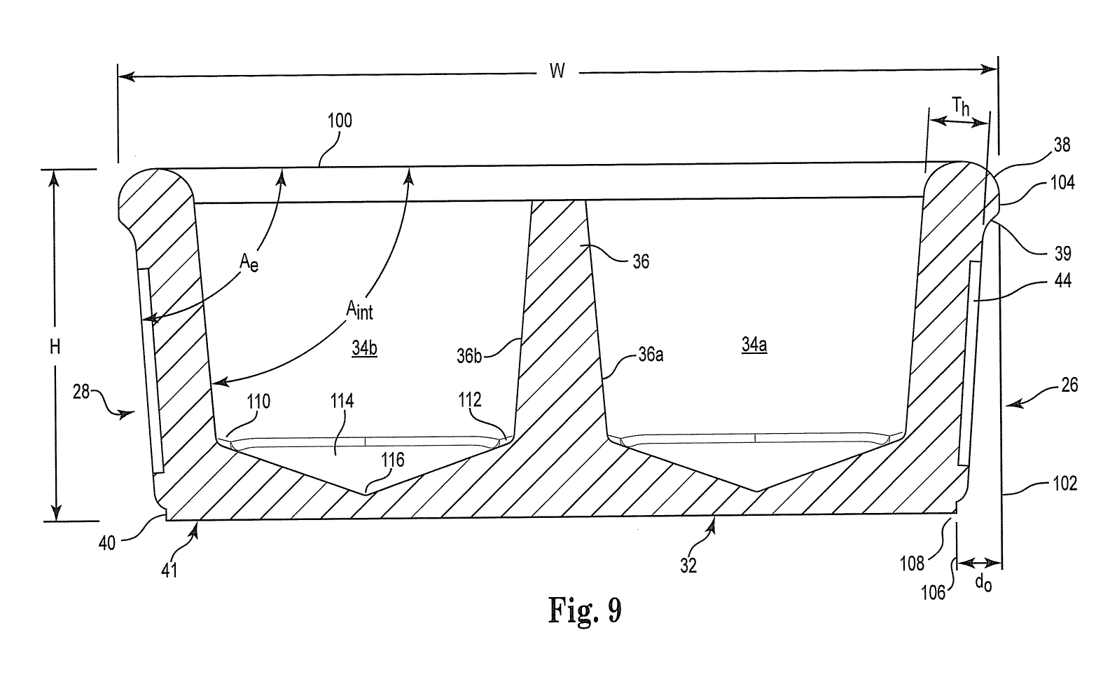

According to one embodiment, as will be described in greater detail below (see FIG. 9, for example), dimensions of bottom side 32, in both lateral and longitudinal directions, are less than dimensions of top side 30 such that the external surfaces of side and end walls 22, 24, 26, and 28 angle inwardly as they extend from top side 30 to bottom side 32. In other embodiments, the external surfaces of side and end walls 22, 24, 26, and 28 may simply be substantially normal to bottom side 32. According to one embodiment, as will also be described in greater detail below, internal surfaces of side and end walls 22, 24, 26, and 28 may be angled or be substantially normal relative to bottom side 32.

According to one embodiment, at least one of the side walls and/or end walls 22, 24, 26, and 28 are formed or molded with inset areas, such as illustrated by inset areas 42, 44. According to one embodiment, such inset areas further include recesses formed or molded therein, such as illustrated by recess 45, which are configured to receive attachment devices 46, wherein attachment devices 46 are configured to selectively secure or hold in place removable decorative panels, such as decorative panel 47, within inset areas 42, 44. According to one embodiment, attachment devices 46 comprise magnets which are inset and secured (e.g. with adhesive) within molded recesses 45 and which are configured to attach to corresponding ferromagnetic elements 48 of decorative panel 47. According to one embodiment, attachment devices 46 and 48 comprise a Velcro based attachment system. In other embodiment, attachment device 46 simply comprises a glue or other suitable adhesive disposed within the recesses 45. Additionally, although illustrated as being rectangular, recesses 42, 44 may be of any number of shapes, such as circular or oval, for example.

It is noted that such decorative panels 48 are not required to be placed within recesses, such as recesses 42, 44. For example, in other embodiments, side and end walls 22, 24, 26, 28 may be formed as simple planar surfaces, but still include attachment devices 46 to which decorative panels may be attached. Decorative panels may be formed of any number or combination of materials including wood, metals, and concrete, to name a few. Such decorative panels may be of any number of shapes and include any number of designs or patterns 49. For example, such decorative panels may include the name of a business, a family name, or depict different motifs, such as seasonal or holiday motifs, for example.

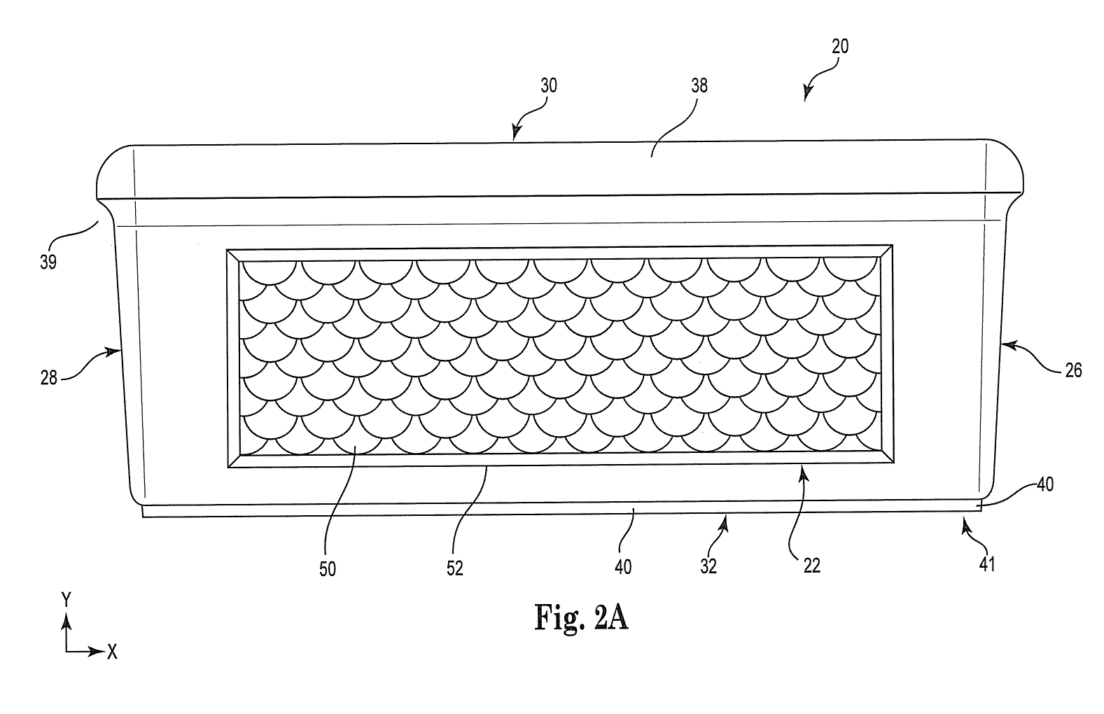

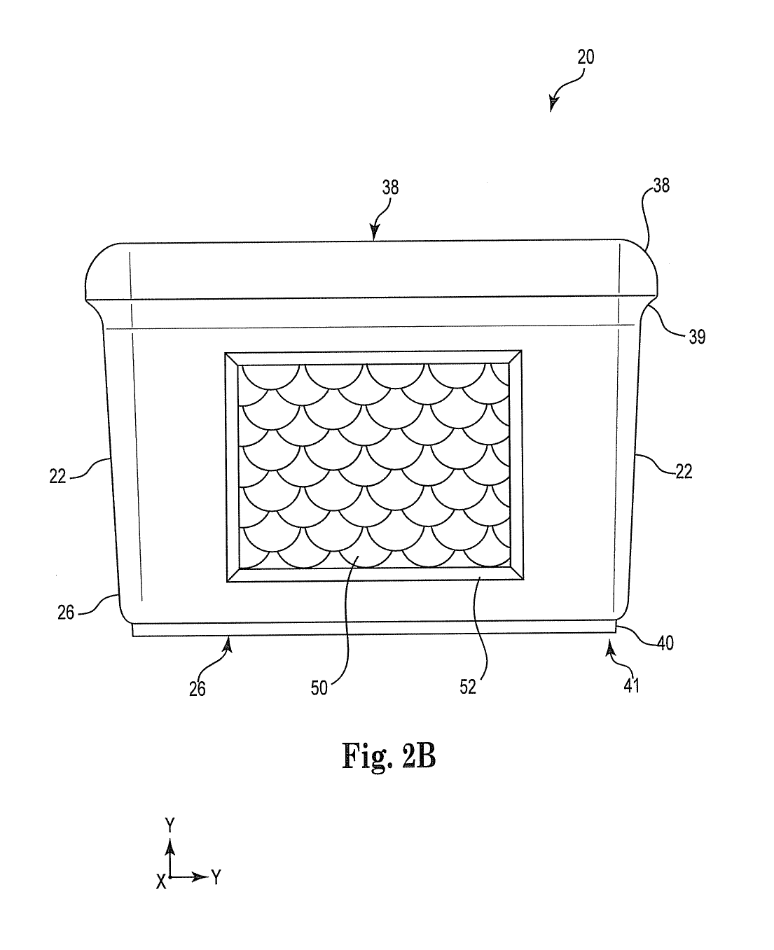

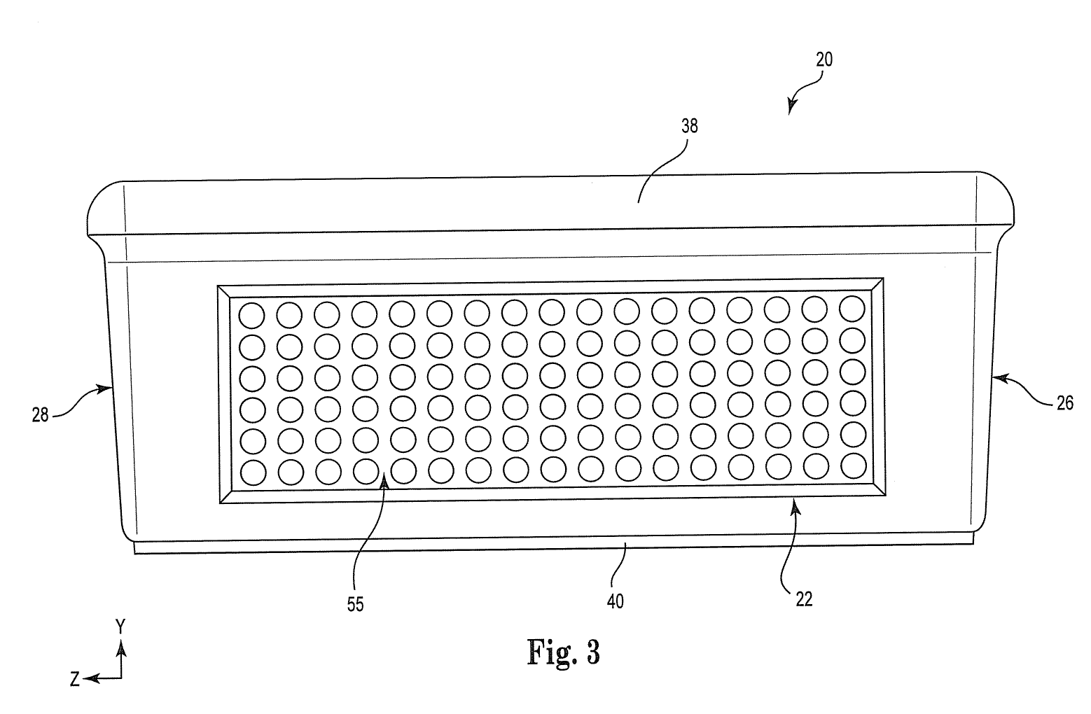

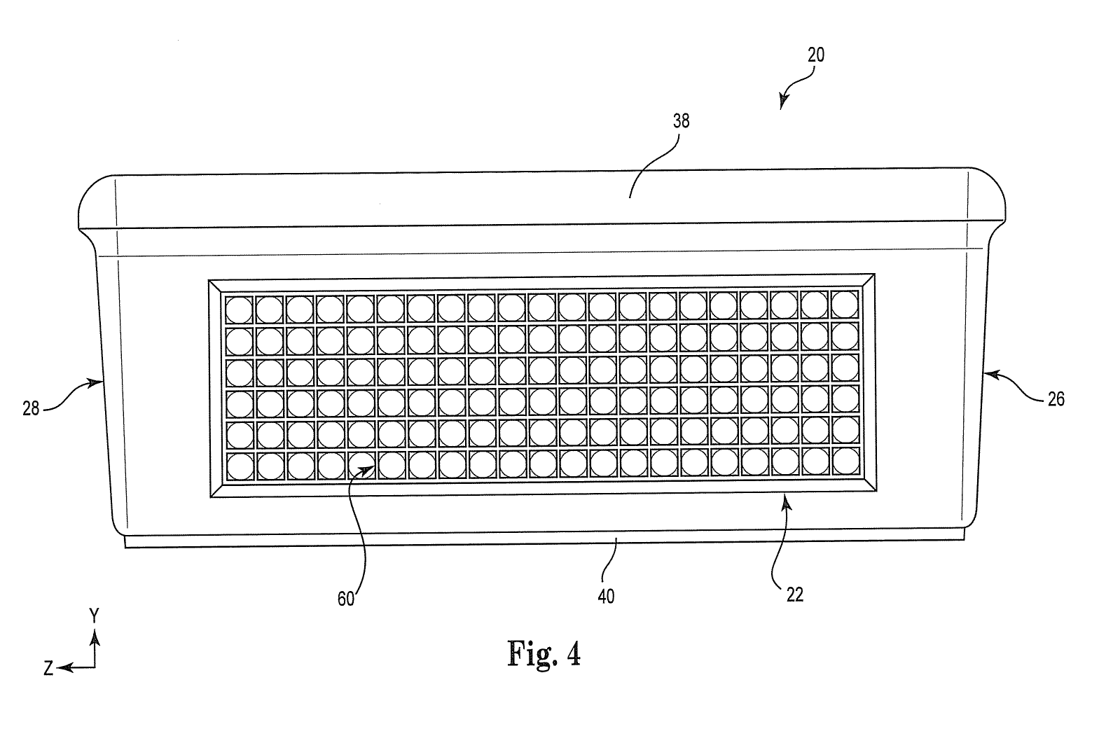

With reference to FIG. 2A, which is a side view of planter box 20 of FIG. 1, according to one embodiment, in lieu of being formed with recesses 42, 44 which are configured to receive decorative panels 47, one or more side and end walls 22, 24, 26, 28 may be directly molded with a decorative design or pattern, such as illustrated by the fish-scale like pattern 50, which includes as part of the pattern an integral border 52. Any number of further patterns may be integrally formed as part of side and end walls 22, 24, 26, 26, as illustrated by the example designs of FIGS. 3 and 4. FIG. 2B is an end view of planter box 20 of FIG. 2A and includes the same scale-like pattern 50.

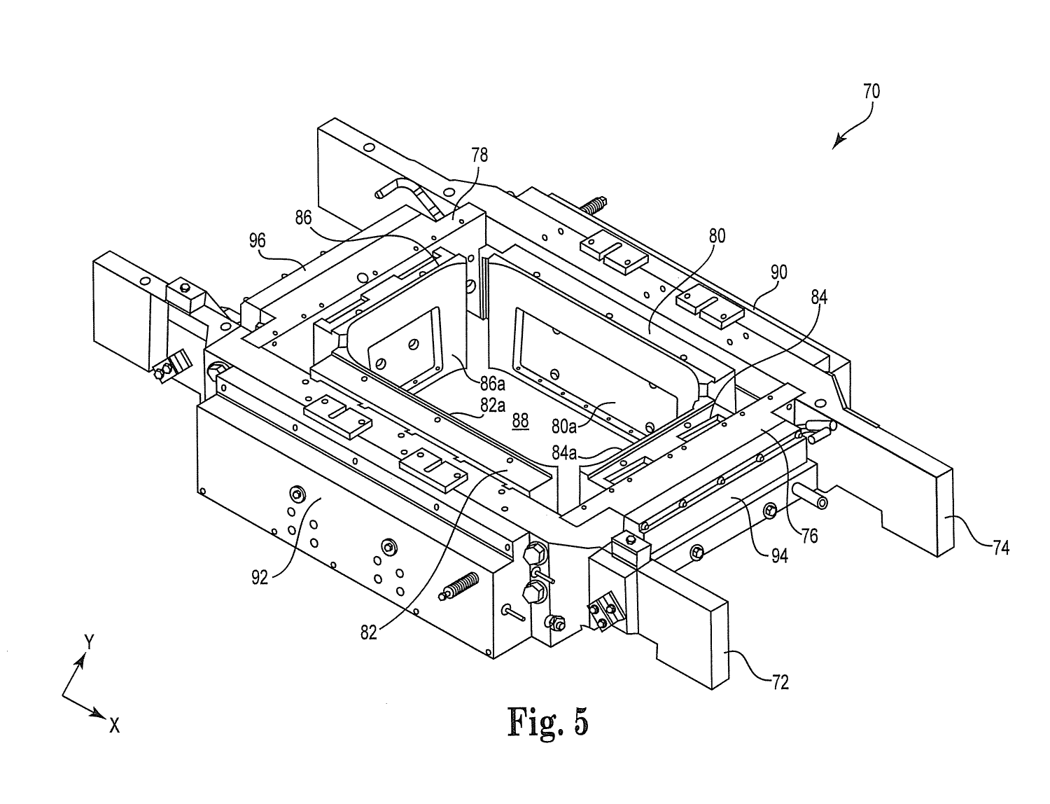

FIG. 5 is a perspective view illustrating one example of a mold assembly 70 for use in a dry-cast concrete block machine for manufacturing concrete planter box 20 in accordance with the present disclosure. Mold assembly 70 includes side members 72, 74 and cross-members 76, 78 which together form a mold box in which moveable liner plates 80, 82, 84, 86 and corresponding faceplates 80a, 82a, 84a, and 86a define a mold cavity 88 for forming dry-cast concrete planter box 20. Drive assemblies 90, 92, 94, 96 are respectively coupled to moveable liners plates 80, 82, 84, 86 and configured to extend and retract moveable liner plates 80, 82, 84, 86 and corresponding faceplates 80a, 82a, 84a, and 86a toward and away from mold cavity 88. As described in greater detail below, faceplates 80a, 82a, 84a, and 86a comprise a negative of the desired shape/pattern to be stamped on the corresponding side of dry-cast concrete planter box 20 to be formed with mold cavity 88 of mold assembly 70.

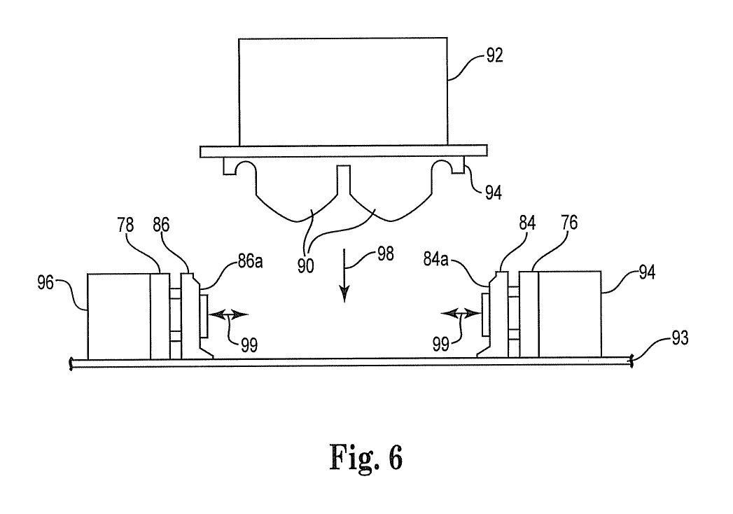

FIG. 6 is a longitudinal cross-sectional view of mold assembly 70 of FIG. 5. As illustrated by FIG. 6, mold assembly 70 further includes a core bar assembly 90 positioned within mold cavity 88, which is configured to form the interior compartments 34a, 34b and removable partition 36 of dry-cast concrete planter box 20, a head shoe assembly 92 which includes a face plate 94 patterned to form the top surfaces of concrete planter box 20 (e.g. top surfaces of removable partition 36 and rim 38), and a pallet 93. Head shoe assembly is moveable up/down with respect to mold cavity 88 as indicated by directional arrow 98.

Drive systems 94, 96 are coupled respectively to movable liner plates 84, 86 and configured to extend and retract liner plates 84, 86 and corresponding faceplates 84a, 86a toward and away from mold cavity 88 as indicated by directional arrows 99. In one embodiment, as will be described in greater detail below, faceplates 84a, 86a are patterned to respectively form rim 38, base 40, and recesses 44 in end walls 26, 26 when moveable liner plates 84 and 86 are in the extended position.

Examples of mold assemblies similar to mold assembly 70 and suitable to be configured for use with this invention are described by U.S. Pat. No. 7,156,645 which is incorporated herein by reference.

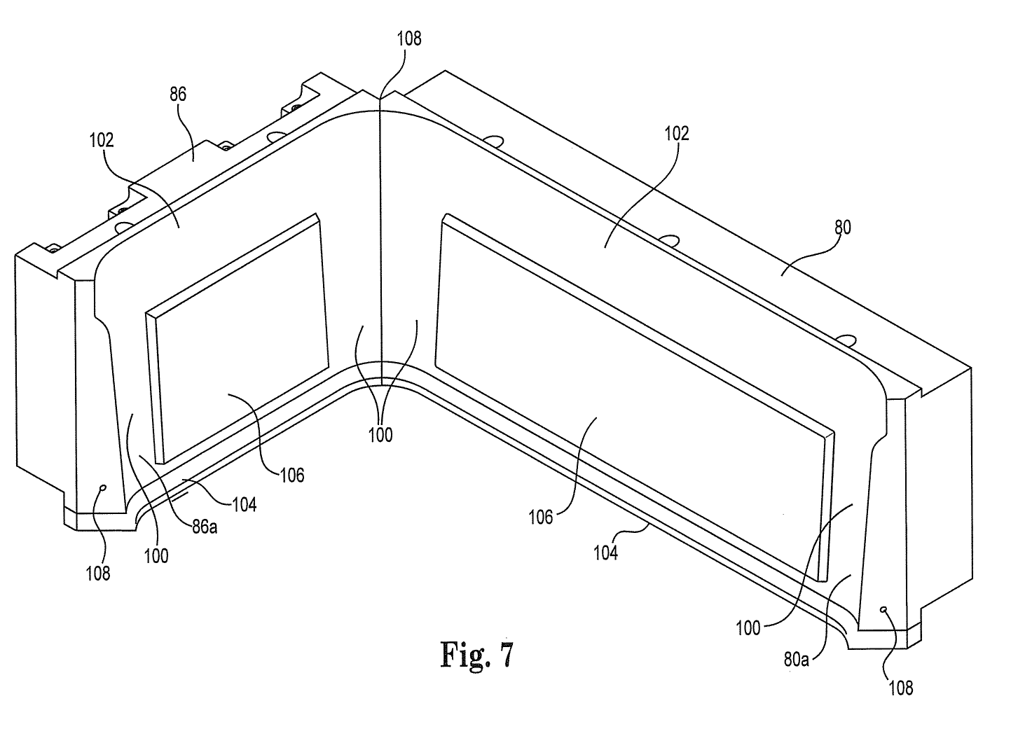

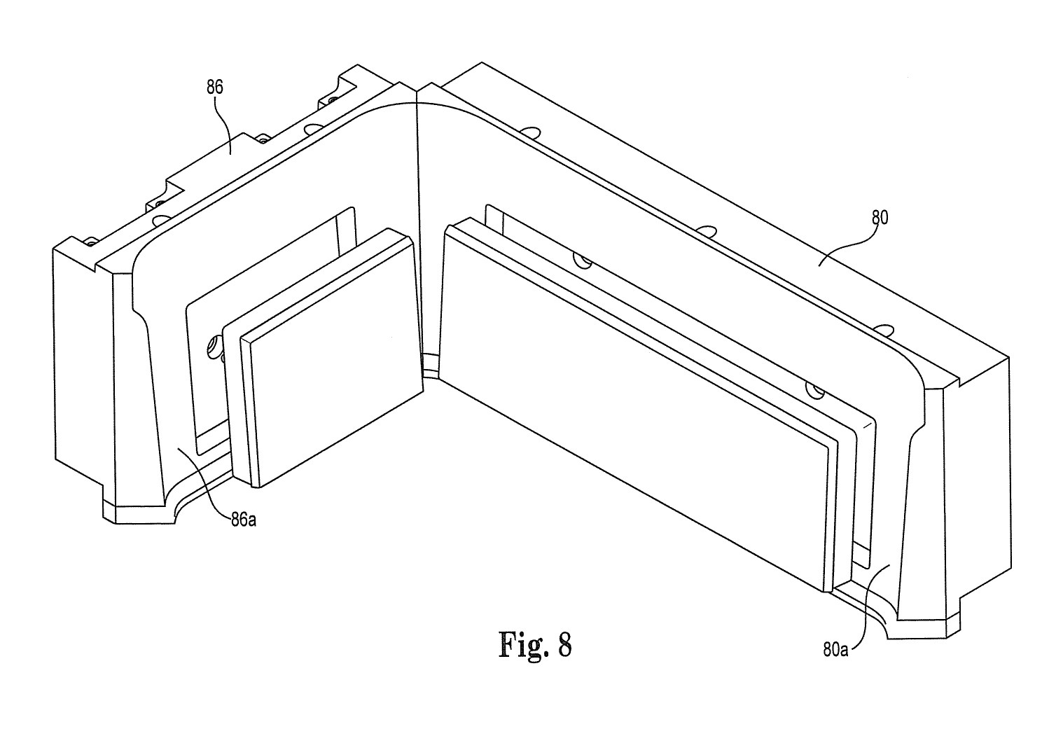

FIGS. 7 and 8 are perspective views illustrating moveable liner plates 80, 86 and corresponding faceplates 80a, 86a. As illustrated, faceplates 80a, 86a each include generally vertical curved elements 100 along each edge for forming the rounded corners of planter box 20, concave-like elements 102 along the upper edges for forming rim 38 of planter box 20, convex-like elements 104 for forming the base 40 of planter box 20, and protruding, rectangular elements 106 for forming recesses 42, 44 in side and end walls 30, 38 of planter box 20. It is noted that faceplates 80a, 86a further included angled surfaces 108 with mate with similar surfaces of adjacent faceplates when in the extended position so as to seal the corners of mold cavity 88.

It is noted that elements 104 and rectangular elements 106 may be separately attached to the moveable liner plates 80, 86. For example, FIG. 8 is a partially exploded view of moveable liner plates 80, 86 showing rectangular elements 106 removed from faceplates 80a, 86a.

In operation, with reference to FIGS. 5-6, mold assembly 70 is coupled to an automated concrete block machine. For ease of illustration, the concrete block machine is not shown in FIGS. 5-6. Examples of concrete block machines for which mold assembly 70 is suitable for use include models manufactured by Columbia and Besser.

Initially, drive assemblies 90, 92, 94, 96 extend liner plates 80, 82, 84, 86 and corresponding faceplates 80a, 82a, 84a, 86a into mold cavity 88. The concrete block machine raises a vibrating table on which a pallet 93 is positioned such that pallet 93 contacts mold assembly 70 and forms a bottom to mold cavity 88 (as illustrated by FIG. 5). The concrete block machine fills mold cavity 88 with a desired concrete mixture and lowers head shoe assembly 92 into mold cavity 88. The concrete block machine then compresses the concrete (e.g. hydraulically or mechanically) with head shoe assembly 92 while simultaneously vibrating mold assembly 70. The compression and vibration together causes concrete to fill any voids within mold cavity 88 and causes the concrete to quickly reach a level of hardness (“pre-cure”) that permits removal of the pre-cured planter box 20 from mold cavity 88.

To remove pre-cured planter box 20, drive assemblies 90, 92, 94, 96 retract moveable liner plates 80, 82, 84, 86 and corresponding faceplates 80a, 82a, 84a, 86a away from the center of mold cavity 88. Head shoe assembly 92 and pallet 92 are then lowered, while the remainder of mold assembly 70 remains stationary, until a lower edge of head shoe assembly 92 is below a lower edge of mold cavity 88 such the pre-cured dry-cast concrete planter box 20 is ejected from mold cavity 88 onto pallet 93. A conveyor system (not shown) then moves pallet 93 and the pre-cured dry-cast concrete planter box 20 to an oven for curing. Head shoe assembly 92 is then raised to its initial position and a next pallet is positioned below mold assembly 70 and the process is repeated to create additional planter boxes.

By employing mold assembly 70 having at least four movable liner plates 80, 82, 84, 86 and corresponding faceplates 80a, 82a, 84a, 86a, along with head shoe assembly 92 having faceplate 94, decorative concrete products, such as concrete planter box 20 can be formed/manufactured using dry-casting methods in lieu of wet-casting methods. Such dry-casting methods enable such decorative concrete products to be manufactured much more quickly and cost effectively as compared to products manufactured using traditional wet-casting techniques.

FIG. 9 is a longitudinal cross-sectional view of planter box 20 of FIG. 1, and illustrates the angled external and internal surfaces of side walls 26, 28 (as well as front and rear walls 22, 24) and those of partition 36, according to one embodiment. According to one embodiment, the external and internal surfaces of the front, rear, and side walls 22, 24, 26, and 28, as illustrated with respect to the external and internal surfaces of side wall 28 in FIG. 9, are respectively formed or molded at an angles Aₑₓ and Aᵢₙₜ with respect to a plane coplanar with a top edge 100 of rim 38. It is noted that the angles Aₑₓ and Aᵢₙₜ are not required to be the same. For example, according to one embodiment, angle Aₑₓ is greater than angle Aᵢₙₜ, and vice-versa. According to one embodiment, angles Aex and Aint are within a range from 75 to 90 degrees from top edge 100.

According to one embodiment, surfaces 36a and 36b of partition 36 are also angled relative to top edge 100 of rim 38. According to one embodiment, surfaces 36a and 36b are angled so as to have an angle substantially identical to that of angle Aᵢₙₜ. According to one embodiment, the internal surfaces of front, rear, and side walls 22, 24, 26, and 28, as well as the surfaces of partition 36 are formed so as to have a radiused or curved transition to an interior surface of bottom side 32, as indicated at 110, 112. According to one embodiment, the interior surface of bottom side 32 includes a depression 114 having a radiused or curved bottom 116. In other embodiment, the internal corners of compartment 34 may be rectangular in shape and have “square” or rectangular corners, or corners of other desired shape.

According to one embodiment, rim 38 has an overhang having an overhang distance d_{O}, which is defined as the horizontal distance between a vertical line 102, which is tangent to an outermost edge 104 of rim 38 in a direction of the width, W, of planter box 20, and a vertical line 106 which is tangent to a corresponding outermost edge 108 of bottom side 32, also in a direction of the width, W, of planter box 20. According to one embodiment, the overhang distance, d_{O}, has a dimension of up to 1.25 inches.

According to one embodiment, planter box 20 has dimensions of approximately 8″H×12″D×20″W, where D is a depth of planter box 20 (into the page in FIG. 9), although any number of other dimensions are possible. According to one embodiment, planter box 20 has front, rear, and side walls 20, 22, 24, and 26 having a thickness, Th. According to one embodiment, the thickness Th is uniform throughout the height, H, of the planter box. According to other embodiments, depending on angles Aex and Aint, the thickness Th of front, rear, and side walls 20, 22, 24, and 26 may vary and be thicker proximate to bottom side 32 than at top side 30, and vice versa. According to one embodiment, thickness Th is between 0.75 and 1.75 inches.

FIG. 10 is a longitudinal cross-sectional view of planter box 20 of FIG. 1, and illustrates the angled external and internal surfaces of side walls 26, 28 (as well as front and rear walls 22, 24) and those of partition 36, according to one embodiment, wherein front, rear, and side walls 22, 24, 26, and 28 do not make a curved transition to from a recess along an edge shared with bottom side 32, but simply merge with bottom side 32 to form a “square” corner, as indicated at 120. Similar to that illustrated by FIG. 9, the overhang distance d_{O}, represents the horizontal distance between a vertical line 102, which is tangent to an outermost edge 104 of rim 38 in a direction of the width, W, of planter box 20, and a vertical line 106 which is tangent to the outermost edge 120 of bottom side 32, also in a direction of the width, W, of planter box 20.

It is noted that the height, H, overhand distance, d_{O}, thickness Tₕ, angles Aₑₓ and Aint, and a concrete mixture employed (e.g. lightweight concrete) are inter-related. For example, a greater height H can be achieved the greater the angle Aₑₓ and, thus, the less the overhang distance, d_{O}. Conversely, a greater overhang distance d_{O} can be achieved the less the angle Aₑₓ and the less the height H. Greater height H, greater overhang distance d_{O}, and greater angles Aₑₓ and Aᵢₙₜ can be achieved when using lightweight concrete. For example, the above described ranges for angles for Aₑₓ and Aᵢₙₜ, and overhang distance d_{O} were achieved using a lightweight concrete mixture.

According to one embodiment, planter box 20 was formed using lightweight concrete. According to one embodiment, the lightweight concrete mixture includes cement, fly ash, sand, and lightweight aggregate, such as cinders, expanded slag, expanded shale and clay, and natural aggregate such as pumice, scoria, volcanic cinders, tuff, and diatomite, perlite, and vermiculite, for example. In other embodiments, the lightweight concrete mixture included cement, fly ash, and lightweight aggregate.

Additionally, although only a few examples of planter box 20 are illustrated and described herein, any number of additional embodiments of planter box 20 are possible. For example, according to one embodiment, rim 38 and base 40 are configured with elements which enable base 40 and rim 38 to interlock with one another and thereby enable planter boxes 20 to be stacked or arranged so as to form various structures comprising multiple planter boxes 20. In other embodiments, in addition to removable panels, planter boxes 20 may be molded with openings configured to receive and retain various other decorative elements, such as accent lights or stereo speakers, for example.

What is claimed is:

1. A dry-cast concrete planter box comprising:
opposed front and rear walls;
opposed side walls extending between the front and rear walls;
a bottom side extending between the front, rear, and side walls;
a top side including a rim extending around a perimeter of the top side along an upper edge of the front, rear, and side walls; and
at least one interior compartment extending from the top side partially through the planter box toward the bottom side which is configured to hold soil.

2. The dry-cast concrete planter box of claim 1, wherein dimensions of the bottom side are less than those of the top side such that the front, rear, and side walls angle inward from the top side toward the bottom side.

3. The dry-cast concrete planter box of claim 1, wherein the at least one compartment includes at least one removable partition wall which divides the at least one interior compartment into sub-compartments compartments, wherein a top edge of the at least one removable partition wall is below a top edge of the rim.

4. The dry-cast concrete planter box of claim 1, wherein corners of the planter box where the side walls and front and rear walls merge comprise rounded corners having a radius in a range of up to 3 inches.

5. The dry-cast concrete planter box of claim 4, wherein both the external and internal corners are rounded.

6. The dry-cast concrete planter box of claim 1; wherein the rim is rounded.

7. The dry-cast concrete planter box of claim 1, wherein the rim overhangs exterior surfaces of the front, rear, and side walls.
